(19) United States
(12) Patent Application Publication
(10) Pub. No.: US 2007/0041314 A1
(43) Pub. Date: Feb. 22, 2007

(54) Apparatus and method for auto-negotiation in a communcation system

(76) Inventors: Raanan Levi, Ofarim (IL); David Pincu, Holon (IL)

Correspondence Address: POWERDSINE LTD., C/O LANDONIP, INC, 1700 DIAGONAL ROAD, SUITE 450, ALEXANDRIA, VA, 22314-2866, US

(21) Appl. No.: 11/206,277

(22) Filed: Aug. 18, 2005

(51) Int. Cl. H04J 1/16; H04J 3/14

(52) U.S. Cl. 370/216; 370/244

(57) ABSTRACT

A communication system comprising: a first device; a second device; and communication cabling comprising four twisted wire pairs arranged to enable communication between the first device and the second device; the first and the second devices being operable to perform auto-negotiation on a communication path comprising a first two of the four twisted wire pairs, and to perform auto-negotiation on a communication path comprising a second two of the four twisted wire pairs, the second two twisted wire pairs being distinct from the first two twisted wire pairs, the first and second devices being operable to enable communication on the communication path comprising the second two twisted wire pairs in the event of a failure of the auto-negotiation on said communication path comprising said first two twisted wire pairs.

### BACKGROUND OF THE INVENTION

The present invention relates to the field of communication systems and more specifically to auto-negotiation in a communication system.

The growth of local and wide area networks based on Ethernet technology has been an important driver for cabling offices and homes with structured cabling systems having multiple twisted wire pairs. In a typical office environment each station or device is connected in a star configuration by a data cable comprising four twisted wire pairs to a central location. A switch or data hub located at the central location provides data switching services within the office environment as well as providing a gateway to the outside world.

Ethernet technology is embodied in the IEEE 802.3 standard whose entire contents are incorporated by reference. The standard defines a number of layers and configurations, including a choice of physical transmission mediums. In particular physical layer specifications 10BASE-T, 100BASE-T and 1000BASE-T are defined for use with twisted wire pairs as the physical transmission medium.

An auto-negotiation function is defined that allows a device to advertise enhanced modes of operation it possesses to a device at the remote end of a link segment and to detect corresponding enhanced operational modes that the other device may be advertising. Auto-negotiation is performed using a modified 10BASE-T link integrity test pulse sequence; however it does not test the link segment characteristics.

FIG. 1 illustrates a high level block diagram of a system 10 operating according to 10BASE-T or alternatively 100BASE-T known to the prior art. System 10 comprises: a first device 20 comprising a transmitting physical layer entity (PHY) 30 and a receiving PHY 40; a second device 50 comprising a receiving PHY 40 and a transmitting PHY 30; and a physical transmission medium 60, illustrated as an unshielded twisted pair cable comprising four twisted wire pairs 70. For clarity, a first twisted wire pair 70 is labeled pair A, and a second twisted wire pair 70 is labeled B.

Transmitting PHY 30 of first device 20 is connected via twisted wire pair 70-A to receiving PHY 40 of second device 50. Transmitting PHY 30 of second device 50 is connected via twisted wire pair 70-B to receiving PHY 40 of first device 20. Thus, a bidirectional communication link is formed between first device 20 and second device 50 comprising twisted wire pairs 70-A, B. The other two twisted wire pairs 70 of unshielded twisted wire pair cable 60 are unused. In an exemplary embodiment as described in the above standard, and as depicted in FIG. 1, a first end of twisted wire pair 70-A is connected to contacts 1 and 2 of the medium dependent interface (MDI) of first device 20 and a second end of twisted wire pair 70-A is connected to contacts 3 and 6 of the MDI of second device 50; and a first end of twisted wire pair 70-B is connected to contacts 1 and 2 of the MDI of second device 50 and a second end of twisted wire pair 70-B is connected to contacts 3 and 6 of the MDI of first device 20.

FIG. 2 illustrates a high level block diagram of a system 100 operating according to 1000BASE-T known to the prior art. System 100 comprises: a first device 110 comprising four bidirectional PHYs 120; a second device 130 comprising four bidirectional PHYs 120; and a physical transmission medium 60, illustrated as an unshielded twisted pair cable comprising four twisted wire pairs 70. For clarity, a first twisted wire pair 70 is labeled pair A, second twisted wire pair 70 is labeled pair B, a third twisted wire pair 70 is labeled pair C and a fourth twisted wire pair 70 is labeled pair D.

A first bidirectional PHY 120 of first device 110 is connected via twisted wire pair 70-A to first bidirectional PHY 120 of second device 130. A second bidirectional PHY 120 of first device 110 is connected via twisted wire pair 70-B to second bidirectional PHY 120 of second device 130. A third bidirectional PHY 120 of first device 110 is connected via twisted wire pair 70-C to third bidirectional PHY 120 of second device 130. A fourth bidirectional PHY 120 of first device 110 is connected via twisted wire pair 70-D to fourth bidirectional PHY 120 of second device 130. Thus, four bidirectional communication links are formed between first device 110 and second device 130 comprising twisted wire pairs 70-A, B,C and D.

In an exemplary embodiment as described in the above standard, and as depicted in FIG. 2, a first end of twisted wire pair 70-A is connected to contacts 1 and 2 of the medium dependent interface (MDI) of first device 110 and a second end of twisted wire pair 70-A is respectively connected to contacts 3 and 6 of the MDI of second device 130. A first end of twisted wire pair 70-B is connected to contacts 1 and 2 of the MDI of second device 130 and a second end of twisted wire pair 70-B is respectively connected to contacts 3 and 6 of the MDI of first device 110. A first end of twisted wire pair 70-C is connected to contacts 4 and 5 of the MDI of first device 110 and a second end of twisted wire pair 70-C is respectively connected to contacts 7 and 8 of the MDI of first device 110. A first end of twisted wire pair 70-D is connected to contacts 4 and 5 of the MDI of second device 130 and a second end of twisted wire pair 70-D is respectively connected to contacts 7 and 8 of the MDI of first device 110.

Clauses 28 and 40 of the above mentioned standard require that auto-negotiation be accomplished on pairs 70-A and 70-B, emulating the arrangement of system 10 of FIG. 1. Thus, for auto-negotiation purposes, as shown in system 100, pairs 70-C and 70-D are not utilized. In the event that a fault occurs in either twisted wire pair 70-C or 70-D, auto-negotiation will proceed unaffected on twisted wire pairs 70-A, B.

FIG. 3 illustrates a high level block diagram of a system 200 which is all respects identical with that of system 100 of FIG. 2, with the exception that twisted wire pair 70-A has been broken. Thus, although twisted wire pairs 70-B, C and D remain functional, system 200 is unable to accomplish auto-negotiation and communication is not enabled.

What is therefore needed, and not known in the prior art, is a method and apparatus for auto-negotiation in a communication system in which a failure of the communication path comprising twisted wire pairs A and B occurs. Such a failure may occur due to a cable tear, connector failure or other hardware failure.

### SUMMARY OF THE INVENTION

Accordingly, it is a principal object of the present invention to overcome the disadvantages of prior art. This is provided in the present invention by enabling auto-negotiation on the communication path comprising pairs A and B, and in the event of a failure of auto-negotiation on the communication path comprising pairs A and B, auto-negotiation on the communication path comprising pairs C and D. In the event that auto-negotiation is successful on the communication path comprising pairs C and D and not successful on the communication path comprising pairs A and B, communication at 100 Mb/s or alternatively at 10 Mb/s is enabled on the communication path comprising pairs C and D.

The invention provides for a communication system comprising: a first device; a second device; and communication cabling comprising four twisted wire pairs arranged to enable communication between the first device and the second device; the first and the second devices being operable to perform auto-negotiation on a communication path comprising a first two of the four twisted wire pairs, and to perform auto-negotiation on a communication path comprising a second two of the four twisted wire pairs, the second two twisted wire pairs being distinct from the first two twisted wire pairs, the first and second devices being operable to enable communication on the communication path comprising the second two twisted wire pairs in the event of a failure of the auto-negotiation on the communication path comprising the first two twisted wire pairs.

In one embodiment the first and second devices are operable to perform the auto-negotiation on the communication path comprising the second two twisted wire pairs only in the event of a failure of the auto-negotiation on the communication path comprising the first two twisted wire pairs. In another embodiment the enabled communication on the second two twisted wire pairs is in accordance with the auto-negotiation on the communication path comprising the second two twisted wire pairs.

In one embodiment the enabled communication on the second two twisted wire pairs is at one of 100 Mb/s and 10 Mb/s. In another embodiment the four twisted wire pairs are comprised within a single unshielded twisted pair cable.

In one embodiment the first two twisted wire pairs are associated with contacts 1, 2, 3 and 6 of a medium dependant interface connector of one of the first device and the second device. In another embodiment the first two twisted wire pairs are associated with contacts 1, 2, 3 and 6 of respective medium dependant interface connectors of each of the first device and the second device.

In one embodiment the second two twisted wire pairs are associated with contacts 4, 5, 7 and 8 of a medium dependant interface connector of one of the first device and the second device. In another embodiment the second two twisted wire pairs are associated with contacts 4, 5, 7 and 8 of respective medium dependant interface connectors of each of the first device and the second device.

In one embodiment the auto-negotiation on the first two twisted pairs is in accordance with IEEE standard 802.3. In another embodiment the auto-negotiation on the second two twisted wire pairs is in accordance with the auto-negotiation on the first two twisted wire pairs.

The invention independently provides for a method of performing auto-negotiation in a communication system comprising a first communication path and a second communication path, each of the first and the communication paths comprising a unique two twisted wire pairs, the method comprising: performing auto-negotiation over the first communication path; performing auto-negotiation over the second communication path; and in the event the performed auto-negotiation over the first communication path is not successful; enabling communication over the second communication path.

In one embodiment the performing auto-negotiation over the second communication path is only in the event of a failure of the performed auto-negotiation over the first communication path. In another embodiment the enabled communication is in accordance with the performed auto-negotiation over the second communication path.

In one embodiment the enabled communication over the second communication path is at one of 100 Mb/s and 10 Mb/s. In another embodiment the first communication path and the second communication path are comprised within a single unshielded twisted pair cable.

In one embodiment the performed auto-negotiation over the first communication path is in accordance with IEEE standard 802.3. In another embodiment the performed auto-negotiation over the second communication path is in accordance with the performed auto-negotiation over the first communication path.

The invention independently provides for a communication system comprising: a first device; a second device; and communication cabling comprising four twisted wire pairs, the four twisted wire pairs comprising a first two twisted wire pairs associated with data communication at 10 Mb/s and a second two twisted wire pairs not associated with data communication at 10 Mb/s; the first and the second devices being operable to perform auto-negotiation via the first two twisted wire pairs, and in the event of a failure of the auto-negotiation, to perform auto-negotiation via the second two twisted wire pairs.

In one embodiment the first and second devices are further operable to communicate over the second two twisted wire pairs at one of 10 Mb/s and 100 Mb/s.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level block diagram of a system operating according to 10BASE-T or alternatively 100BASE-T known to the prior art;

FIG. 2 illustrates a high level block diagram of a system operating according to 1000BASE-T known to the prior art; and

FIG. 3 illustrates a high level block diagram of a system which is all respects identical with that of FIG. 2, with the exception that a twisted wire pair normally used for auto-negotiation has failed;

FIG. 4 illustrates a high level block diagram of a system operating in accordance with principle of the current invention;

FIG. 5 illustrates a high level flow chart of the method of operation according to a first embodiment of the principle of the current invention; and

FIG. 6 illustrates a high level flow chart of the method of operation according to a second embodiment of the principle of the current invention.

### DETAILED DESCRIPTION OF PREFERRED EMBODIMENTS

The present embodiments enable auto-negotiation on the communication path comprising pairs A and B, and in the event of a failure of auto-negotiation on the communication path comprising pairs A and B, auto-negotiation on the communication path comprising pairs C and D. In the event that auto-negotiation is successful on the communication path comprising pairs C and D and not successful on the communication path comprising pairs A and B, communication at 100 Mb/s or alternatively at 10 Mb/s is enabled on the communication path comprising pairs C and D.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

FIG. 4 illustrates a high level block diagram of a system 300 operating in accordance with principle of the current invention comprising: a first device 310 comprising four bidirectional PHYs 320; a second device 330 comprising four bidirectional PHYs 320; and a physical transmission medium 60, illustrated as an unshielded twisted pair cable comprising four twisted wire pairs 70. For clarity, a first twisted wire pair 70 is labeled pair A, second twisted wire pair 70 is labeled pair B, a third twisted wire pair 70 is labeled pair C and a fourth twisted wire pair 70 is labeled pair D.

A first bidirectional PHY 320 of first device 310 is connected via twisted wire pair 70-A to first bidirectional PHY 320 of second device 330. A second bidirectional PHY 320 of first device 310 is connected via twisted wire pair 70-B to second bidirectional PHY 320 of second device 330. A third bidirectional PHY 320 of first device 310 is connected via twisted wire pair 70-C to third bidirectional PHY 320 of second device 330. A fourth bidirectional PHY 320 of first device 310 is connected via twisted wire pair 70-D to fourth bidirectional PHY 320 of second device 330. Thus, four bidirectional communication links are formed between first device 310 and second device 330 comprising respective twisted wire pairs 70-A, B,C and D.

In an exemplary embodiment as described in the above standard, a first end of twisted wire pair 70-A is connected to contacts 1 and 2 of the medium dependent interface (MDI) of first device 310 and a second end of twisted wire pair 70-A is respectively connected to contacts 3 and 6 of the MDI of second device 330. A first end of twisted wire pair 70-B is connected to contacts 1 and 2 of the MDI of second device 330 and a second end of twisted wire pair 70-B is respectively connected to contacts 3 and 6 of the MDI of first device 310. A first end of twisted wire pair 70-C is connected to contacts 4 and 5 of the MDI of first device 310 and a second end of twisted wire pair 70-C is respectively connected to contacts 7 and 8 of the MDI of first device 310. A first end of twisted wire pair 70-D is connected to contacts 4 and 5 of the MDI of second device 330 and a second end of twisted wire pair 70-D is respectively connected to contacts 7 and 8 of the MDI of first device 310.

In operation, system 300 first attempts auto-negotiation on the auto-negotiation communication path comprising twisted wire pairs 70 A, B. In the event that auto-negotiation is successful, communication is enabled in accordance with advertised enhance modes of operation. In a preferred embodiment known to the prior art, in the event that gigabit Ethernet is advertised by both first device 310 and second device 330 the communication path comprising twisted wire pairs 70 C, D are tested to confirm that operation according to gigabit Ethernet is possible. In the event that the communication path comprising twisted wire pairs 70 C, D does not provide communication, operation according to 100 Mb/s or alternatively 10 Mb/s is enabled along the communication path comprising twisted wire pairs 70 A, B.

In the event that auto-negotiation on twisted wire pairs 70 A, B fails, auto-negotiation is attempted in accordance with the principle of the current invention on twisted wire pairs 70 C, D. In another embodiment in accordance with the principle of the current invention auto-negotiation is attempted on both twisted wire pairs 70 A, B and twisted wire pairs 70 C, D. Such a second, or parallel, auto-negotiation is advantageous in that capabilities are recognized at a single auto-negotiation phase. Additionally, any problems or errors on twisted wire pairs 70 C, D are detected in this manner. In the event that auto-negotiation on twisted wire pairs 70 C, D is successful and auto-negotiation on twisted wire pairs 70 A, B is not successful, operation according to 100 Mb/s or alternatively 10 Mb/s is enabled along the communication path comprising twisted wire pairs 70 C, D. It is to be understood that operation according to 100 Mb/s or alternatively 10 Mb/s is enabled according to protocols supported by both first and second devices 310, 330.

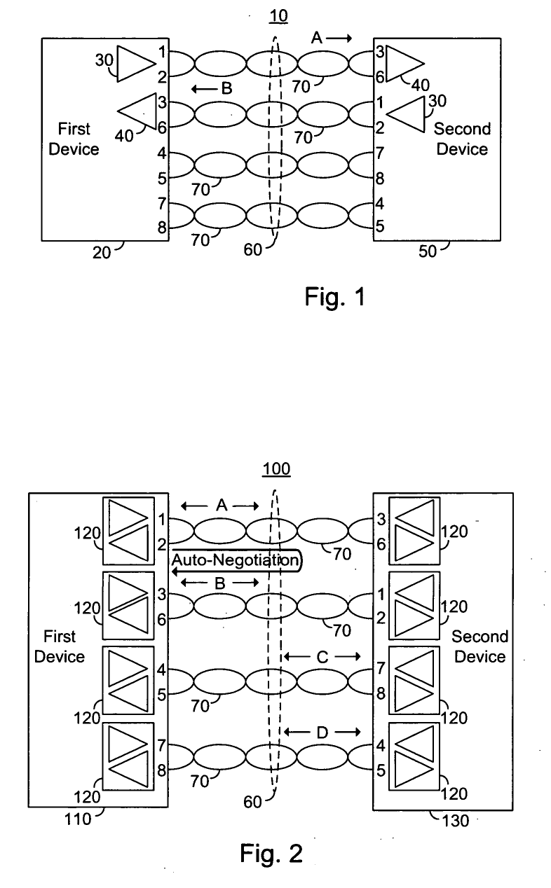

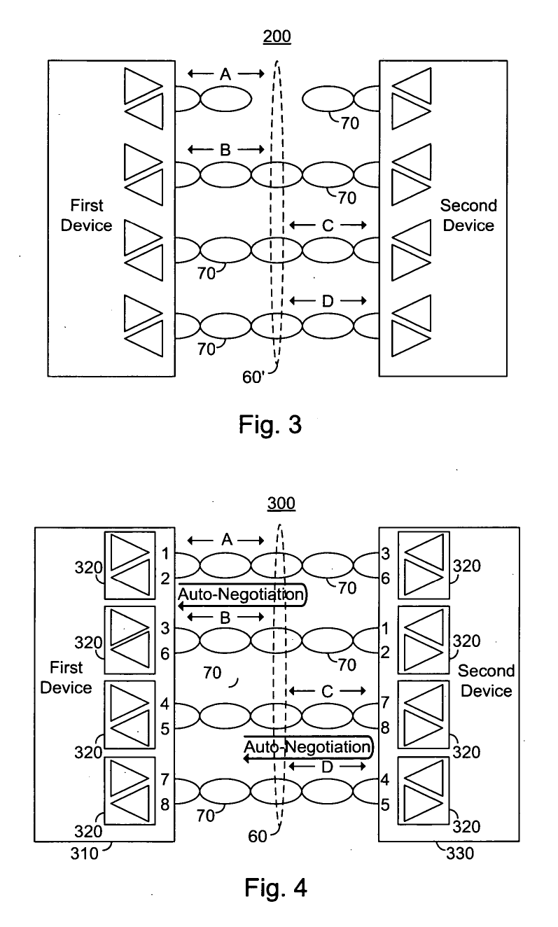

It is a feature of the current invention that communication at 100 Mb/s or alternatively 10 Mb/s is enabled along the communication path comprising twisted wire pairs 70 C, D due to the existence of bidirectional PHY 320 connected thereto. Thus, in contrast to system 100 of FIG. 1, auto-negotiation and communication at 10 Mb/s or alternatively 100 Mb/s is enabled along the communication path comprising twisted wire pairs 70 C, D.

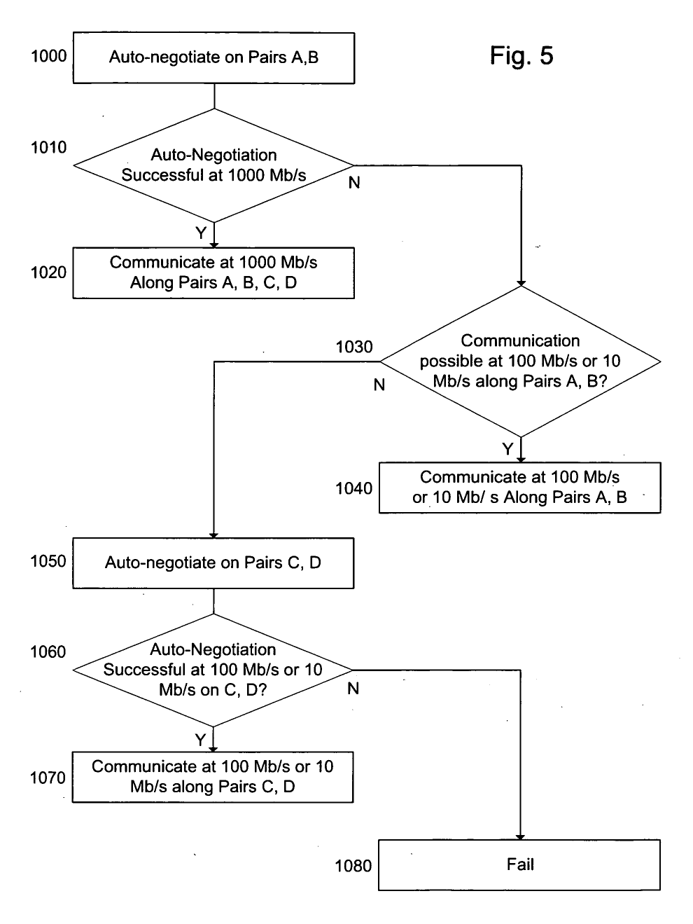

FIG. 5 illustrates a high level flow chart of the method of operation according to a first embodiment of the principle of the current invention. In stage 1000 auto-negotiation is attempted on the communication path comprising twisted wire pairs 70 A, B. In stage 1010 the auto-negotiation of stage 1000 is examined to see if it was successful at 1000 Mb/s. In the event that in stage 1010 the auto-negotiation of stage 1000 was determined to be successful at 1000 Mb/s, in stage 1020 communication at 1000 Mb/s utilizing twisted wire pairs 70 A, B, C, D is enabled.

In the event that in stage 1010 the auto-negotiation of stage 1000 was determined not to be successful at 1000 Mb/s, in stage 1030 the auto-negotiation of stage 1000 is examined to determine if communication at 100 Mb/s or alternatively at 10 Mb/s is possible on the communication path comprising twisted wire pairs 70 A, B. In the event that in stage 1030 the auto-negotiation of stage 1000 is determined to indicate that communication at 100 Mb/s or alternatively 10 Mb/s is possible on the communication path comprising twisted wire pairs 70 A, B, in stage 1040 communication at 100 Mb/s or alternatively 10 Mb/s is enabled on the communication path comprising twisted wire pairs 70 A, B.

In the event that in stage 1030 the auto-negotiation of stage 1000 is determined to indicate that communication at 100 Mb/s or alternatively 10 Mb/s is not possible on the communication path comprising twisted wire pairs 70 A, B, in stage 1050 auto-negotiation on the communication path comprising twisted wire pairs 70 C, D is attempted at 100 Mb/s or alternatively 10 Mb/s. In stage 1060 the auto-negotiation of stage 1050 is examined to determine if communication at 100 Mb/s or alternatively at 10 Mb/s is possible on the communication path comprising twisted wire pairs 70 C, D. In the event that in stage 1060 the auto-negotiation of stage 1050 is determined to indicate that communication at 100 Mb/s or alternatively 10 Mb/s is possible on the communication path comprising twisted wire pairs 70 C, D, in stage 1070 communication at 100 Mb/s or alternatively 10 Mb/s is enabled on the communication path comprising twisted wire pairs 70 C, D. In the event that in stage 1060 the auto-negotiation of stage 1050 is determined to indicate that communication at 100 Mb/s or alternatively 10 Mb/s is not possible on the communication path comprising twisted wire pairs 70 C, D, in stage 1080 a failure of communication is flagged.

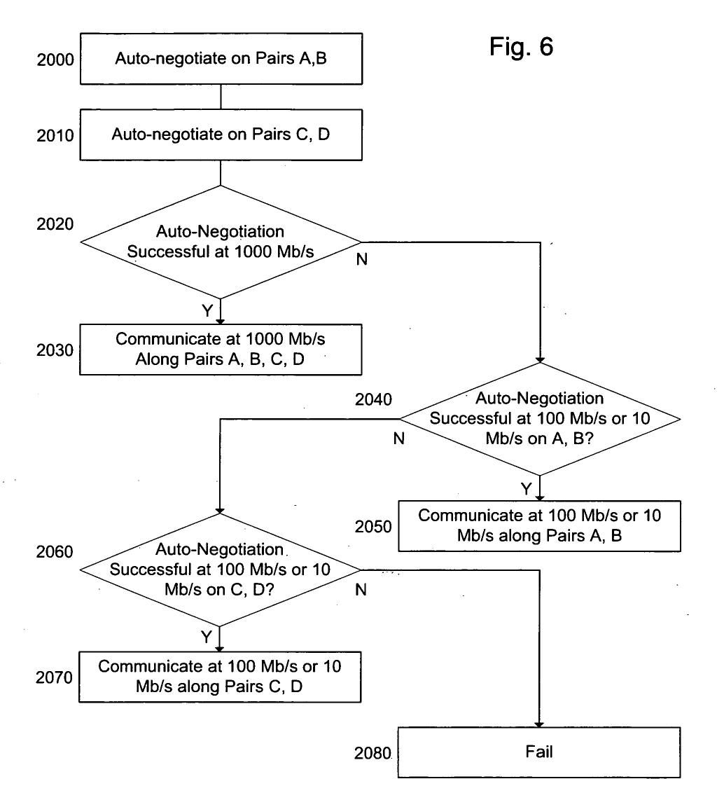

FIG. 6 illustrates a high level flow chart of the method of operation according to a second embodiment of the principle of the current invention. In stage 2000 auto-negotiation is attempted on the communication path comprising twisted wire pairs 70 A, B. In stage 2010 auto-negotiation is attempted on the communication path comprising twisted wire pairs 70 C, D. In stage 2020 the auto-negotiation of stage 2000 is examined to see if it was successful at 1000 Mb/s. In the event that in stage 2020 the auto-negotiation of stage 2000 was determined to be successful at 1000 Mb/s, in stage 2030 communication at 1000 Mb/s utilizing twisted wire pairs 70 A, B, C, D is enabled.

In the event that in stage 2020 the auto-negotiation of stage 2000 was determined not to be successful at 1000 Mb/s, in stage 2040 the auto-negotiation of stage 2000 is examined to determine if communication at 100 Mb/s or alternatively at 10 Mb/s is possible on the communication path comprising twisted wire pairs 70 A, B. In the event that in stage 2040 the auto-negotiation of stage 2000 is determined to indicate that communication at 100 Mb/s or alternatively 10 Mb/s is possible on the communication path comprising twisted wire pairs 70 A, B, in stage 2050 communication at 100 Mb/s or alternatively 10 Mb/s is enabled on the communication path comprising twisted wire pairs 70 A, B.

In the event that in stage 2040 the auto-negotiation of stage 2000 is determined to indicate that communication at 100 Mb/s or alternatively 10 Mb/s is not possible on the communication path comprising twisted wire pairs 70 A, B, in stage 2060 the auto-negotiation of stage 2010 on the communication path comprising twisted wire pairs 70 C, D is examined to determine if communication at 100 Mb/s or alternatively at 10 Mb/s is possible on the communication path comprising twisted wire pairs 70 C, D. In the event that in stage 2060 the auto-negotiation of stage 2010 is determined to indicate that communication at 100 Mb/s or alternatively 10 Mb/s is possible on the communication path comprising twisted wire pairs 70 C, D, in stage 2070 communication at 100 Mb/s or alternatively 10 Mb/s is enabled on the communication path comprising twisted wire pairs 70 C, D. In the event that in stage 2060 the auto-negotiation of stage 2010 is determined to indicate that communication at 100 Mb/s or alternatively 10 Mb/s is not possible on the communication path comprising twisted wire pairs 70 C, D, in stage 2080 a failure of communication is flagged.

In the event of a failure of ongoing communication at 1000 Mb/s, preferably auto-negotiation in accordance with either the method of FIG. 5 or FIG. 6 is attempted to reestablish communication.

The present embodiments thus enable auto-negotiation on the communication path comprising pairs A and B, and in the event of a failure of auto-negotiation on the communication path comprising pairs A and B, auto-negotiation on the communication path comprising pairs C and D. In the event that auto-negotiation is successful on the communication path comprising pairs C and D and not successful on the communication path comprising pairs A and B, communication at 100 Mb/s or alternatively at 10 Mb/s is enabled on the communication path comprising pairs C and D.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description and which are not in the prior art.

We claim:

1. A communication system comprising:
a first device;
a second device; and
communication cabling comprising four twisted wire pairs arranged to enable communication between said first device and said second device;
said first and said second devices being operable to perform auto-negotiation on a communication path comprising a first two of said four twisted wire pairs, and to perform auto-negotiation on a communication path comprising a second two of said four twisted wire pairs, said second two twisted wire pairs being distinct from said first two twisted wire pairs, said first and second devices being operable to enable communication on said communication path comprising said second two twisted wire pairs in the event of a failure of said auto-negotiation on said communication path comprising said first two twisted wire pairs.

2. A communication system according to claim 1 wherein said first and second devices are operable to perform said auto-negotiation on said communication path comprising said second two twisted wire pairs only in the event of a failure of said auto-negotiation on said communication path comprising said first two twisted wire pairs.

3. A communication system according to claim 1, wherein said enabled communication on said second two twisted wire pairs is in accordance with said auto-negotiation on said communication path comprising said second two twisted wire pairs.

4. A communication system according to claim 1, wherein said enabled communication on said second two twisted wire pairs is at one of 100 Mb/s and 10 Mb/s.

5. A communication system according to claim 1, wherein said four twisted wire pairs are comprised within a single unshielded twisted pair cable.

6. A communication system according to claim 1, wherein said first two twisted wire pairs are associated with contacts 1, 2, 3 and 6 of a medium dependant interface connector of one of said first device and said second device.

7. A communication system according to claim 1, wherein said first two twisted wire pairs are associated with contacts 1, 2, 3 and 6 of respective medium dependant interface connectors of each of said first device and said second device.

8. A communication system according to claim 1, wherein said second two twisted wire pairs are associated with contacts 4, 5, 7 and 8 of a medium dependant interface connector of one of said first device and said second device.

9. A communication system according to claim 1, wherein said second two twisted wire pairs are associated with contacts 4, 5, 7 and 8 of respective medium dependant interface connectors of each of said first device and said second device.

10. A communication system according to claim 1, wherein said auto-negotiation on said first two twisted pairs is in accordance with IEEE standard 802.3.

11. A communication system according to claim 1, wherein said auto-negotiation on said second two twisted wire pairs is in accordance with said auto-negotiation on said first two twisted wire pairs.

12. A method of performing auto-negotiation in a communication system comprising a first communication path and a second communication path, each of the first and said communication paths comprising a unique two twisted wire pairs, the method comprising:
performing auto-negotiation over the first communication path;
performing auto-negotiation over the second communication path; and
in the event said performed auto-negotiation over the first communication path is not successful;
enabling communication over the second communication path.

13. A method according to claim 12, wherein said performing auto-negotiation over the second communication path is only in the event of a failure of said performed auto-negotiation over the first communication path.

14. A method according to claim 12, wherein said enabled communication is in accordance with said performed auto-negotiation over the second communication path.

15. A method according to claim 12, wherein said enabled communication over the second communication path is at one of 100 Mb/s and 10 Mb/s.

16. A method according to claim 12, wherein the first communication path and the second communication path are comprised within a single unshielded twisted pair cable.

17. A method according to claim 12, wherein said performed auto-negotiation over the first communication path is in accordance with IEEE standard 802.3.

18. A method according to claim 12, wherein said performed auto-negotiation over the second communication path is in accordance with said performed auto-negotiation over the first communication path.

19. A communication system comprising:
a first device;
a second device; and
communication cabling comprising four twisted wire pairs, said four twisted wire pairs comprising a first two twisted wire pairs associated with data communication at 10 Mb/s and a second two twisted wire pairs not associated with data communication at 10 Mb/s;
said first and said second devices being operable to perform auto-negotiation via said first two twisted wire pairs, and in the event of a failure of said auto-negotiation, to perform auto-negotiation via said second two twisted wire pairs.

20. A communication system according to claim 19, wherein said first and second devices are further operable to communicate over said second two twisted wire pairs at one of 10 Mb/s and 100 Mb/s.
